(19) United States
(12) Patent Application Publication
(10) Pub. No.: US 2012/0168339 A1
(43) Pub. Date: Jul. 5, 2012

(54) HOUSING FOR ELECTRONIC DEVICE AND METHOD FOR MANUFACTURING THE SAME

(75) Inventors: TE-SHENG JAN, Tu-Cheng (TW); YU-TAO CHEN, Tu-Cheng (TW); CHUN-CHE YEN, Tu-Cheng (TW); JIAN-MING LIU, Shenzhen City (CN); DE-HUA LIU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/223,172

(22) Filed: Aug. 31, 2011

(30) Foreign Application Priority Data
Dec. 29, 2010 (CN) 201010611404.6

(51) Int. Cl. B65D 79/00; B29C 45/14

(52) U.S. Cl. 206/524.1; 264/279

(57) ABSTRACT

A method of manufacturing a housing includes steps of providing a transparent film including a first surface and an opposing second surface; applying adhesive material on the first surface of the transparent film; placing the treated transparent film in a mold, the second surface of the transparent film attached to the inner molding surface of the mold. Plastic material is injected into the mold to form a plastic base overlaid with the transparent film; and defining a predetermined decorative pattern in a top portion of the plastic base beneath the adhesive layer using a laser etching process. The decorative pattern cannot be sensed by touch rough because it is located between the plastic base and the cover layer.

### BACKGROUND

1. Technical Field

The present disclosure relates to housings, particularly to a housing for electronic devices and a method of manufacturing the housing.

2. Description of Related Art

The external appearance of the housing of the portable electronic device (such as mobile telephones and electronic notebooks) has become a key factor for attracting consumers.

In-Mold Labeling (IML) process is a typical method to produce such decorative plastic housing. The process is carried out by molding a plastic substrate to combine with a plastic film in a mold. Prior to the substrate being molded, a predetermined pattern, text, or pictures are printed on the film. The molded substrate is then combined with the patterned film. The pattern may not be abraded or eroded because it is located between the film and the substrate. However, in this method, the ink of the pattern printed on the film is often repulsive to the plastic substrate, thus causing the pattern to become unclear.

Another method to produce such decorative plastic housings is laser etching process. Laser etching is a process of using lasers to etch or mark a predetermined pattern, text, or pictures on a plastic substrate. In this way, the pattern is defined on the surface of the substrate, the pattern can be touched and sensed by the user. However, a coating of protecting layer is deposited on the plastic substrate, but the thickness of the housing is increased. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an assembled, isometric view of an electronic device in accordance with an exemplary embodiment.

FIG. 2 is schematic cross-sectional views illustrating a housing of the electronic device according to the embodiment of FIG. 1.

FIG. 3 is a flowchart of a process of manufacturing a housing of the electronic device according to the embodiment of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

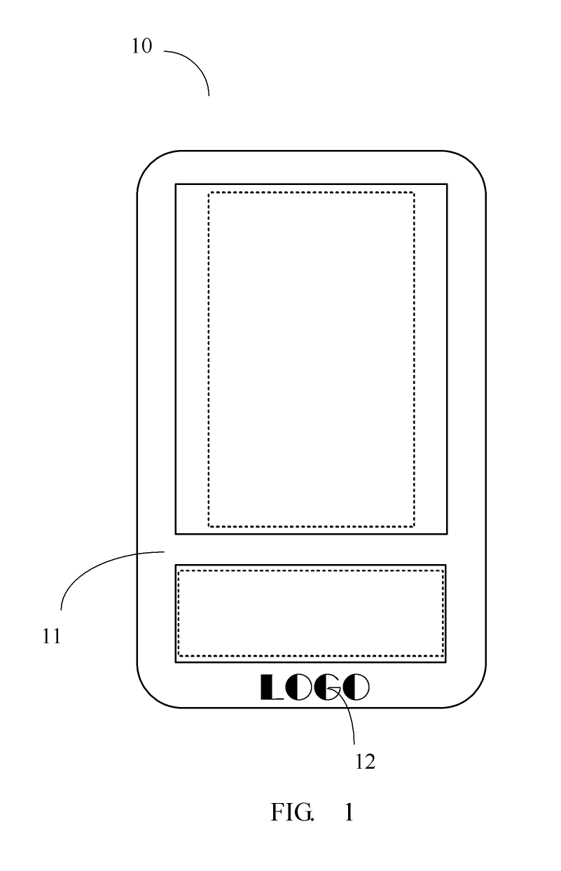

Referring to FIG. 1, an embodiment of an electronic device 10 is illustrated. The electronic device 10 can be a digital photo frame (DPF), an E-paper reading device, a MP3 or a cell phone. The electronic device 10 includes a housing 11 with a decorative pattern 12. In this embodiment, the decorative pattern 12 is a logo.

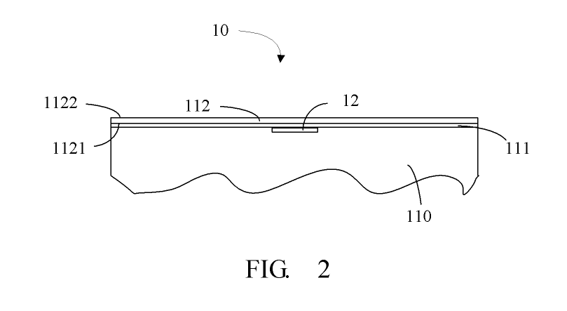

Referring to FIG. 2, the housing 11 includes a plastic base 110, a transparent cover layer 112 and an adhesive layer 111 configured to combine the plastic base 110 and the cover layer 112 together. The cover layer 112 may be made of a material selected from the group consisting of polyisoprene (PI), polycarbonate (PC), or polyethylene terephthalate (PET), and any suitable combination thereof. The thickness of the cover layer 112 is in the range from 0.1 mm to 0.5 mm. The cover layer 112 includes a first surface 1121 and an opposing second surface 1122, the adhesive layer 111 is attached on the first surface 1121 of the cover layer 112. The adhesive layer 111 is made of hot melt adhesive material.

The decorative pattern 12 is formed on the plastic base 110 via laser etching process. A laser is irradiated on the predetermined regions of the housing 11, the laser passes though the cover layer 112 and defines a predetermined decorative pattern 12 extending on the surface of the plastic base 110.

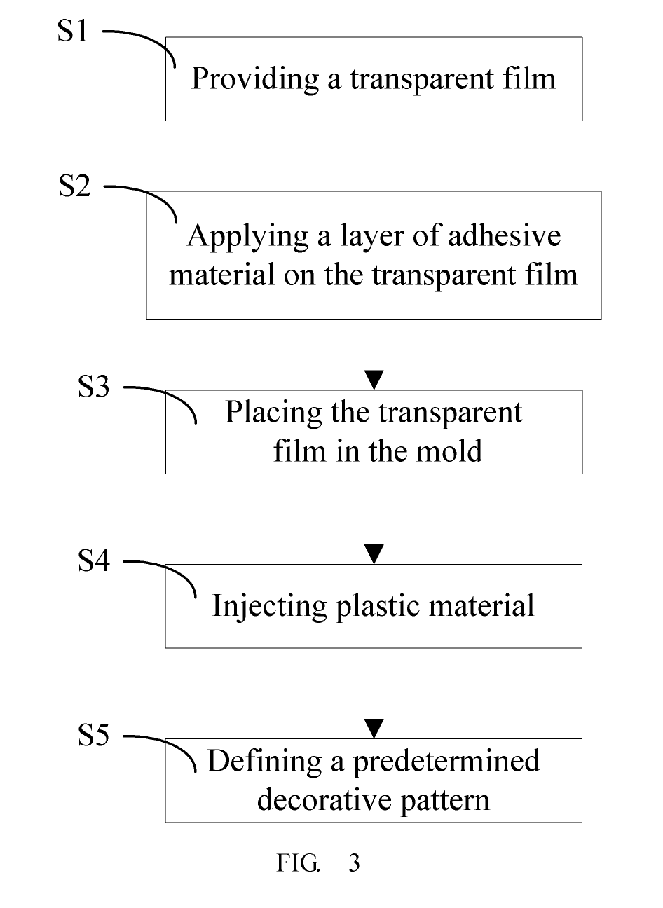

Referring to FIG. 3, a flowchart of a process of manufacturing the housing 11 is illustrated.

In step S1, providing a transparent film including a first surface and an opposing second surface. The transparent film may be made of a material selected from the group consisting of polyisoprene (PI), polycarbonate (PC), or polyethylene terephthalate (PET), and any suitable combination thereof. The thickness of the transparent film is in the range from 0.1 mm to 0.5 mm.

In step S2, applying adhesive material on the first surface of the transparent film to form an adhesive layer 111 on the first surface, the second surface is free of the adhesive material thereon.

In step S3, placing the treated transparent film in a mold, the second surface of the transparent film attached to the inner molding surface of the mold. In other embodiments, the transparent film is cut to a predetermined shape prior to being placed in the mold.

In step S4, injecting plastic material into the mold to form a plastic base 110 overlaid with the transparent film, the adhesive layer 111 sandwiched between the plastic base 110 and the transparent film. During the injection molding process, the plastic material forms the plastic base 110 overlaid with the transparent film. The transparent film forms the cover layer 112. The transparent film is combined with the plastic base 110 via the adhesive material.

In step S5, defining a predetermined decorative pattern in a top portion of the plastic base using a laser etching process. The laser passes though the cover layer 112 and defines the predetermined decorative pattern 12 extending on the surface of the plastic base 110.

The decorative pattern 12 may not be sensed by touch rough because it is located between the plastic base 110 and the cover layer 112. The cover layer 112 is stuck securely to the plastic base 110 via the hot melt adhesion, which occurs during the molding process.

It is to be understood, however, that even though numerous characteristics and advantages of the present disclosure have been set forth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A method of manufacturing a housing, comprising:
providing a transparent film comprising a first surface and an opposing second surface;
applying adhesive material on the first surface of the transparent film to form an adhesive layer on the first surface, the second surface is free of the adhesive material thereon;
placing the treated transparent film in a mold, the molding including an inner molding surface, the second surface of the transparent film attached to the inner molding surface of the mold;
injecting plastic material into the mold to form a plastic base overlaid with the transparent film, the adhesive layer sandwiched between the plastic base and the transparent film; and
defining a predetermined decorative pattern in a top portion of the plastic base beneath the adhesive layer using a laser etching process.

2. The method according to claim 1, further comprising cutting the transparent film to a predetermined shape prior to placing the transparent film in the mold.

3. The method according to claim 1, wherein the transparent film is made of a material selected from the group consisting of polyisoprene, polycarbonate, and polyethylene terephthalate.

4. The method according to claim 1, wherein the thickness of the transparent film is in the range from 0.1 mm to 0.5 mm.

5. The method according to claim 1, wherein the adhesive material is hot-melt adhesive material.

6. A plastic housing, comprising:
a plastic base;
a transparent cover layer attached on the plastic base; and
a decorative pattern formed on the plastic base using a laser etching process.

7. The housing according to claim 6, wherein the transparent cover layer is made of a material selected from the group consisting of polyisoprene, polycarbonate, and polyethylene terephthalate.

8. The housing according to claim 6, wherein the transparent cover layer is attached on the surface of the plastic base using in-mold labeling process.

9. The housing according to claim 6, wherein the thickness of the transparent cover layer is in the range from 0.1 mm to 0.5 mm.

10. The housing according to claim 6, wherein an adhesive layer is arranged between the plastic base and the transparent cover layer to adhere the transparent cover layer on the plastic base.
